(19) United States
(12) Patent Application Publication
(10) Pub. No.: US 2005/0251420 A1
(43) Pub. Date: Nov. 10, 2005

(54) System and method for managing an office

(75) Inventors: Robert A. Dixon, Powell, OH (US); Ethan F. List, Dublin, OH (US); Robert Q. Smith, Lewis Center, OH (US)

Correspondence Address: STANDLEY LAW GROUP LLP, 495 METRO PLACE SOUTH, SUITE 210, DUBLIN, OH, 43017, US

(73) Assignee: TurboOffice.com, Inc., Dublin, OH (US)

(21) Appl. No.: 11/087,900

(22) Filed: Mar. 23, 2005

Related U.S. Application Data
(60) Provisional application No. 60/555,749, filed on Mar. 23, 2004.

(51) Int. Cl. G06F 17/60

(52) U.S. Cl. 705/2

(57) ABSTRACT

A system and method for managing an office involve an integrated website on a remote server computer. The website is accessed remotely by a user using conventional computer hardware. All office management software and graphic user interfaces are stored on the server computer, which is connected to the user's hardware using a web browser. All office management functions are performed at the server computer at the user's direction. The web site provides a completely integrated office management capability, with user information stored securely at the server computer. Communications between the server computer and the user, as well as data storage, are encrypted to meet or exceed federal medical privacy standards.

The present application claims the benefit of U.S. provisional application 60/555,749, filed 23 Mar. 2004, which is incorporated by reference as if fully recited herein.

### TECHNICAL FIELD

The present invention relates to managing an office, particularly a professional office. More particularly, the present invention relates to a system and method to manage a practice (e.g., a medical and/or surgical practice, a dental practice, or a law practice), using a secure connection between a server and a plurality of hardware devices, each of the hardware devices adapted for connection to the server without having to install special software or hardware.

### BACKGROUND OF THE ART

Many professionals, such as physicians, maintain, or are a part of an office that needs to be managed. In some cases, especially with surgeons, these professionals spend significant amounts of time away from their primary office. For example, a surgeon will be in hospitals where he or she has privileges, either operating or checking on patients, and, in many cases, in a secondary office or offices. Also, the nature of the job makes it highly desirable for the surgeon to have secure access to manageable matters while at home. Even though software programs have been developed that enable office functions to be managed, the programs are available only on a computer located in the primary office.

Some of the office functions that need to be managed include the scheduling of appointments and procedures, generation and maintenance of patient records and files, reporting results and billing. Additionally, when a professional works in a group practice setting, there is a pressing need for the individual practitioners to coordinate office issues amongst themselves.

As a small business, an individual medical practice or even a group practice can be quite frustrated by the current state of the medical software industry. Software solutions often look great when the software is run on the vendor's machines, which are already installed and configured, during a sales presentation. However, after the software sale, the user often experiences unpleasant surprises. As a small business, the medical practice is not able to afford the cost of a full time IT person, or at least an IT maintenance contract, that is often needed to keep the system running. There are often periodic software upgrades that a user needs to purchase in order to keep his system from going out of date. There are also additional costs when a user needs to add a workstation to his system. Whenever an upgrade occurs, more money is typically spent to have an IT person make it work on each machine at each facility. Also, after deciding to purchase upgraded software, upgraded hardware may be needed to run the upgraded software.

Also, as generic office management software is put into service on local computers in a large number of different practices, there is little or no capability provided to customize that software to match the practice with which it is used. These generic packages may require the practitioner to buy more in the way of software and/or hardware than is actually needed, in order to obtain the needed components.

It is therefore, an unmet goal of the prior art to provide an office management software package, particularly software customized to a professional practice, in which the software, which may be located on a server that is remote even to the primary office of the practice, is accessed in a secure manner as an individualized website from any of a number of pieces of conventional hardware from any remote site that can be connected to the website.

### SUMMARY OF THE INVENTION

This and other advantages of the present invention are provided by a system for managing a professional practice office, comprising at least one server computer, an integrated website, and at least one hardware device. The integrated website is hosted on the server computer and provides a plurality of integrated office management software applications and associated graphical user interface views. The hardware device is adapted for secure electronic connection to the integrated website.

In some of the embodiments, the secure electronic connection is provided by the internet, and a network browser software package is used by the hardware device to access the integrated website.

In some of the embodiments, the hardware device is selected from the group consisting of: desktop personal computers, personal data assistants, laptop personal computers, notebook personal computers and tablet personal computers.

In some of the embodiments, the integrated website is adapted to provide software applications and associated graphical user interface views for use in managing a medical practice, a surgical practice or a combined medical/surgical practice.

In some of the embodiments, the system also comprises a means for storing and accessing data for the integrated website, connected to or integral with the server computer.

In some of the embodiments,the plurality of integrated office management software applications comprises at least two of the following: a secured log-in portal software application, an office manager software application; a patient information software application, a schedule manager software application, and a reporting software application. In some further embodiments, a billing manager software application is also included.

In the system, the secured log-in portal software provides a drop box for remote electronic entry of pre-authorized information.

In embodiments where it is present, the billing manager software application provides the filing of claims with health insurance providers, tracking of billing and collections and patient invoicing.

In all embodiments directed to medical applications, the secure electronic connection is adapted to fully comply with medical data privacy rules and regulations.

Other aspects and advantages of the present invention are provided by a method for managing a professional practice office, comprising the steps of:
a. providing an integrated website on a server computer, the integrated website having at least two integrated office management software applications, each of the integrated office management software applications having at least one graphical user interface view associated therewith;
b. allowing secure access to the integrated website by a plurality of users using network browser software installed on a hardware device remote from the server computer;
c. allowing the plurality of users to individually perform office management functions using the graphical user interface views associated with any one of the office management software applications; and
d. allowing the plurality of users to move seamlessly from the one office management software application to another of the offcie management software applications.

In some aspects of this method, the secure access is accomplished through an encrypted internet connection, particularly one in which the step of allowing secure access is adapted to fully comply with medical data privacy rules and regulations.

In some other aspects of the inventive method, the at least two integrated office management software applications are selected from a group consisting of: an office manager software application; a chart manager software application; and a schedule manager software application. In some further embodiments, the at least two integrated office management software applications include a billing manager software application.

In yet other aspects of the invention, the method further comprises the step of accessing and storing data for the integrated website on a database connected to or integral with the server computer.

Further limitations and disadvantages of conventional, traditional, and proposed approaches will become apparent to one of skill in the art, through comparison of such systems and methods with the present invention as set forth in the remainder of the present application with reference to the drawings.

### BRIEF DESCRIPTION OF THE DRAWING

These and other advantages of the present invention will be better understood when reference is made to the accompanying drawings, wherein identical parts are designated by identical reference numbers, and wherein:

FIG. 1 is a schematic representation of an embodiment of a system of the present invention, directed at managing an professional medical practice office;

FIG. 2 is a screen shot of a home page graphic user interface (GUI), provided by the system of FIG. 1;

FIG. 3 is a screen shot of a drop box GUI, provided by the system of FIG. 1;

FIG. 4 is a screen shot of a first office management GUI;

FIG. 5 is a screen shot of a second office management GUI;

FIG. 6 is a screen shot of a third office management GUI;

FIG. 7 is a screen shot of a fourth office management GUI;

FIG. 8 is a screen shot of a first patient information GUI, provided by the system of FIG. 1;

FIG. 9 is a screen shot of a second patient information GUI;

FIG. 10 is a screen shot of a third patient information GUI;

FIG. 11 is a screen shot of a fourth patient information GUI;

FIG. 12 is a screen shot of a fifth patient information GUI;

FIG. 13 is a screen shot of a first schedule manager GUI;

FIG. 14 is a screen shot of a second schedule manager GUI;

FIG. 15 is a screen shot of a third schedule manager GUI;

FIG. 16 is a screen shot of a fourth schedule manager GUI;

FIG. 17 is a screen shot of first billing manager GUI;

FIG. 18 is a screen shot of a second billing manager GUI;

FIG. 19 is a screen shot of a third billing manager GUI;

FIG. 20 is a screen shot of a bank deposit ticket generated by the billing manager software application;

FIG. 21 is a screen shot of a fourth billing manager GUI;

FIG. 22 is a screen shot of a fifth billing manager GUI; and

FIG. 23 is a screen shot of a sixth billing manager GUI.

### DETAILED DESCRIPTION OF A PREFERRED EMBODIMENT

While the preferred embodiment described herein is directed specifically at a medical/surgical practice in which the physician/surgeon and other necessary users are able to interact in a secure manner with a professional practice management system (PPMS), especially one that is remotely located, one of ordinary skill will readily understand that the present invention is not limited to a medical/surgical practice situation. The inventive concepts taught herein are more widely applicable to other professional practices.

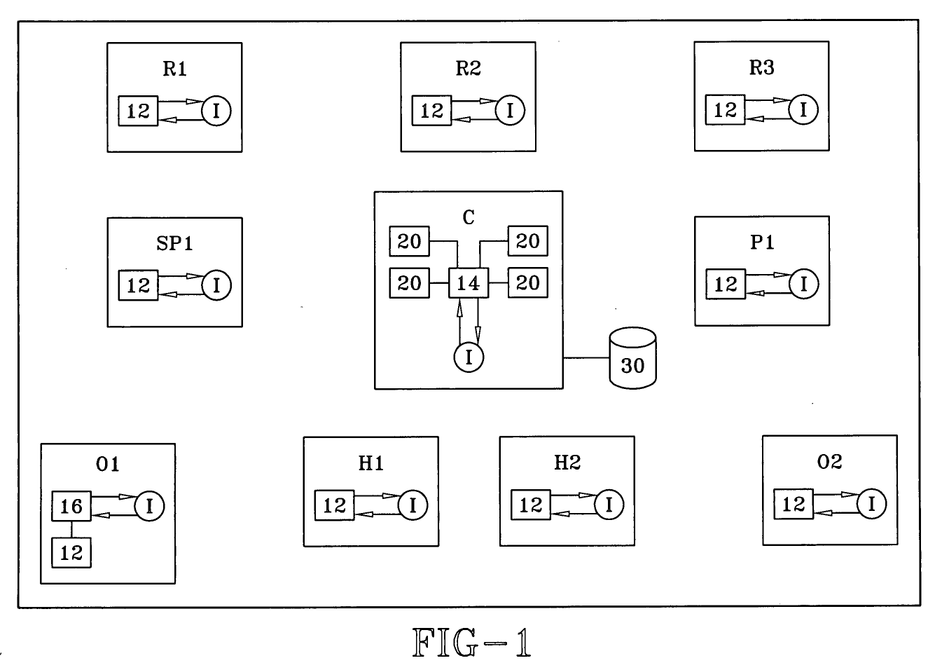

With the physician/surgeon practice model in mind, attention is now directed to FIG. 1, which provides a model of a surgical practice with which the system of the present invention may be used. For this scenario, a hypothetical medical practice comprising three surgeons is proposed. The surgeons have privileges at two hospitals H1, H2 and the practice maintains two offices 01, 02, with 01 located near H1 and 02 located near H2. Of the offices, 01 is the primary office and 02 is a secondary office. Each of the surgeons has a respective residence R1, R2, R3. The practice interacts with a number of service providers, one of which is illustrated as SP1. These service providers can be other physicians, pharmacies, transcription services, and health care coverage providers, just to name a few of the types of providers with which the practice will interact. The pratice deals with a number of patients at any given time. The residence of one such patient, designated as P1, is shown.

Shown centrally positioned in FIG. 1 is a server computer C, although it will be readily understood that, of all of the components shown in FIG. 1, it is this component that can most easily be located remotely from the others without significant disruption. While server computer C is illustrated as being separate from any of the other components, there is no particular reason why it cannot be physically located within the confines of any of the other physical components, such as one of the offices, one of the hospitals, one of the service providers, or even one of the residences. Similarly, while this particular practice is shown being served by server computer C, there is no reason why server computer C cannot simultaneously act as in the identical role for a number of additional professional practices having scopes larger than or smaller than the professional practice being described. In fact, the sharing of a server computer C by many professional practices is a feature provided by the present invention.

Shown in each of the locations (other than server computer C) is a hardware device 12, as is generally commercially known and available. Such a hardware device could be, for illustrative purposes only, a desktop personal computer, a laptop personal computer, a notebook personal computer, a tablet personal computer or a personal data assistant (“PDA”). In all of the cases, the hardware device 12 is shown as being adapted so that it may be electronically connected in a secure manner to an integrated website 14 that is maintained on server computer C. In most of the cases, the hardware device 12 is shown as being able to send and receive information in the secure manner with a source 1, with which the integrated website 14 is also electronically connected in a secure manner, as a part of server computer C. In one of the cases, the hardware device 12 is shown as being hardwired to another hardware device 16 at the location, wherein the other hardware device 16 has the secure electronic connection with source l. The example of this shown in FIG. 1 is at 01, to show that one or more hardware devices 12 might be connected through the central hardware device 16 with the integrated website 14. Hardware devices 12 are well-known and will be expected to provide, at the minimum, a processing unit, a screen, and input peripherals, typically a mouse and/or keyboard. In addition to being able to be hardwired to another hardware device, such as 16, the hardware device 12 may be connected wirelessly through a local area network to hardware device 16. It is anticipated that in most embodiments of the present invention, the hardware devices 12 will represent off-the-shelf, commercially available technology, including off-the-shelf, commercially available browser software.

In many embodiments of the present invention, the inventive system will make the secure electronic connection of the hardware devices 12 with the integrated website 14 through a global informational network, such as the Internet, as designated by the earlier-identified source 1. Other technologies may emerge in the future that will replace the Internet as the preferred source I of the secure electronic connection.

In many embodiments, the server computer C will have other functionality besides hosting the integrated website 14. The integrated website 14, which may also be referred to as the professional practice management system (PPMS), provides a plurality of integrated office management software applications 20. Each of the integrated office management software applications 20 has at least one associated graphical user interface (GUI) view, which is viewed by a user of the integrated website 14 on one of the hardware devices 12, once the user has connected with the integrated website 14. In other words, all necessary functional software is installed on server computer C, such that the user, having a hardware device 12 with appropriate browser software (and proper access authorization, as explained in more detail below) installed thereon, may actively use the integrated website 14. In most embodiments, a database 30 will be integral with or directly peripheral to server computer C. Data communicated by or to users of the integrated website 14 will be maintained in known manners on database 30 and/or server computer C. Of course, it will known to utilize multiple databases 30 and/or servers C to provide the integrated website 14 for a number of different practices, and the particular details of doing this will be known to those of skill without describing them in more detail here.

Since all of the functionality of the integrated website 14 is contained in server C and associated database 30, no special hardware or software are required at any hardware device 12 for a user to be fully operational from the remote location of the hardware device. Accordingly, a user with a hardware device 12 and a secure electronic connection, provided by conventional technologies such as dial up, cable modem, DSL or other technologies not presently known, but to be developed in the future, has access to the functionality provided by the integrated website 14, limited only be the authorization of the particular user. The user can access the integrated website 14 from any location where the user can establish the requisite secure electronic connection I, such as in the office, the home, in the hospital or on the road, at any time of day or night. All office management functions are performed at the integrated website 14 through the integrated office management software applications 20 and the respective graphical user interface (GUI) views.

The server computer C, the integrated website 14 and the database 30 are all maintained by a PPMS service provider, which may or may not (and usually will not) be the professional practice using the integrated website 14. The PPMS service provider handles all software and hardware enhancements (i.e., upgrades) in a manner that does not prevent a user from using the integrated website 14.

Each of the PPMS functional software applications 20 are integrated and hosted on the server computer C. This results in significantly lower costs, ease of access, and ease of maintainability for the user. A user simply subscribes to the PPMS service, receives the training needed, and connects his hardware device 12, having an installed browser, to the integrated website 14 through the secure electronic source 1. The user does not have to purchase special software or hardware. The user simply maintains his hardware device (or devices) 12 and manages his office or practice remotely using any or all of the functionality provided by the integrated website 14, depending on the user's needs. All user data is securely and redundantly stored and backed up by the PPMS service provider on the database 30, the server computer C or a combination of both. The user's data is secured through password and user identification (ID) entry as well as an encryption scheme, which would typically be a 128-bit encryption. Because of this, the system complies fully with the present requirements of the Health Insurance Portability and Accountability Act (HIPAA). Since the encryption scheme is preferably implemented on the server computer C and is not a direct component of the integrated website 14, maintaining compliance should be transparent to the user of the system, even if compliance requirements are changed at some point. The changes will be incorporated directly into server computer C.

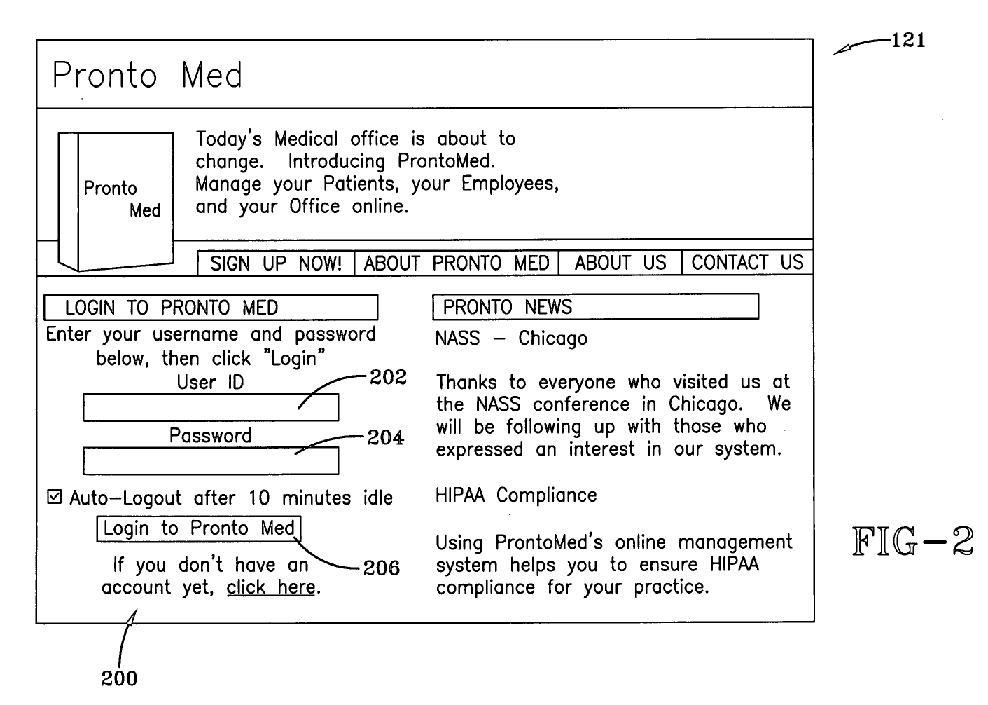

In FIGS. 2 through 23, details of the present invention system and method will be illustrated by typical GUIs that have been prepared using commercially-available software sold by Microsoft Corporation. Because of the wide use of this Microsoft software, persons of ordinary skill in this art will readily recognize the capabilities provided to a user by the GUI, even if those capabilities are not explicitly described herein.

When a user has connected a local hardware device 12 through a secure connection source I to the server computer C, the user's display screen will show a home page GUI 121, as illustrated in FIG. 2, associated with a corresponding home page software application. The user reaches the home page software application without going through any security, so when the home page GUI 121 is displayed, a portion of that display will be a log-in box 200. In FIG. 2, a portion of the home page GUI 121 has the log-in box 200, containing an entry box 202 for a User ID, an entry box 204 for a password, and a Log-in button 206, which is “clicked on”to initiate log-in. Other graphics, text information and buttons may be shown on the home page GUI 121, but they are not necessary for proper operation of the home page software application by the user.

If the user enters a valid ID and password, then the user is welcomed to PPMS and may proceed to use additional applications, as will described in further detail below.

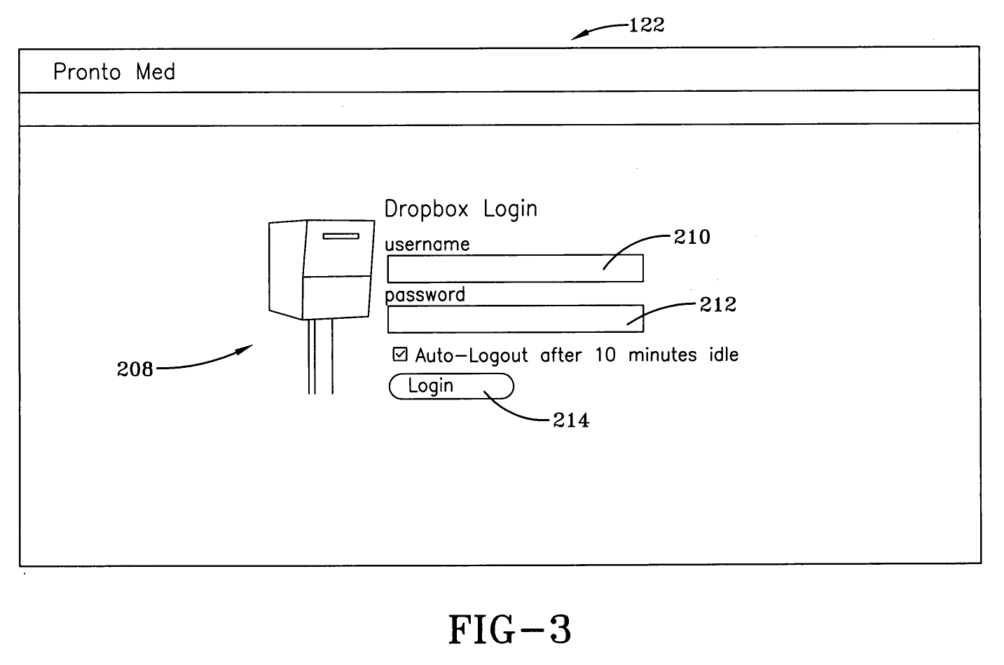

There is at least one additional portal provided into the PPMS. In many situations, a pre-qualified service provider of the user, such as SP1 of FIG. 1, may need access to the user's PPMS in order to deposit test results or the like. For example, a user physician needs a set of x-ray images of the cervical spine and head of a patient. When the imaging work is scheduled with the service provider, a scheduling transmission made to the service provider from the PPMS associates a unique transaction code with the requested service. As a pre-qualified provider, the service provider has previously been established a user ID and a password. When the requested work is completed and the results are ready for uploading from the service provider's computer to the PPMS, the service provider may use a local hardware device to connect through a secure connection source to the server computer, and particularly to a drop box GUI 122 associated with a corresponding drop box software application. The drop box software application 122 is reached without going through any security, and when the drop box GUI 122 is displayed, it will provide a drop box log-in box 208, as shown in FIG. 3. The drop box log-in box 208 will have an entry box 210 for a User ID, an entry box 212 for a password, and a Log-in button 214, which is “clicked on”to initiate log-in.

If the user enters a valid ID and password, then the service provider is welcomed to the PPMS and is directed to upload the data, associating it with the pre-determined transaction code. In the system of the present invention, each and every transaction is identified by a unique transaction code, assigned by the server computer. In a preferred embodiment, this transaction code has time-related elements to identify the date and time of the transaction and randomly-assigned elements to assure its unique nature. If the server computer C serves a plurality of professional practices, as would be expected to be the case, a service provider who is pre-qualified with more than one of the practices may actually upload data for more than one practice in a single sign-in session. The drop box software application then distributes the data appropriately to the different practices, at which time the practitioner who ordered the work may access the data as a part of the patient's record, as will be described further below. In this manner, the data passes into the patient record without ever needing to be viewed by anyone, including office personnel in the practitioner's office.

In another use of the drop box portal, patients, especially new patients, may use the drop box software application, or a variation thereof, to provide medical history information, insurance information, or the like, to the practice. In such a case, the patient is provided with an ID and password, along with a template for entering the requested information. Either at home before a scheduled office visit, or in the office waiting room using a hardware device provided by the practice, the patient may fill in the template with the requested information and upload it, through the drop box software application, directly into the patient's record, which would have been established when the appointment was scheduled. While the drop box GUI 122 associated with the corresponding drop box software application may be used for this, it is also possible to establish a separate patient information log-in system, although it would functionally operate in a very analogous manner to the service provider drop box. Appropriately, the information supplied by the patient may pass into the patient record without ever needing to be viewed by anyone, including office personnel in the practitioner's office.

Within the professional practice, the log-in of a registered user will open up a variety of further software applications to the user. Because the overall software package is resident on a server computer and preferably serves a plurality of professional practices, each individual user can customize a view of the available office information which he or she is authorized to view. This can include the physical arrangement of content on the selected GUls, the color schemes, etc. The logged-in user may move freely among the authorized software application, depending upon that user's authorization. For example, an accounting clerk in the office has no need for access to any medical elements of a patient record, but may need access to address information, etc., and that access may be provided while access to the unneeded elements is denied by PPMS.

The PPMS website 14 is fully integrated, so that a user may move from one user-friendly graphical user interface view to another, without having to deliberately close one software application before opening another. To the user, the website 14 functions in the manner of one seamless software application.

In addition to the previously-described portal software applications, the PPMS of the present invention comprises at least an “Office Manager”software application, a “Chart Manager”software application, and a “Schedule Manager”software application. In some embodiments, the present invention will also include a “Billing Manager”software application. The functionality provided by each of these software applications is easily accessed via any of a plurality of graphical user interface views by simply using the input capability of the hardware device being used.

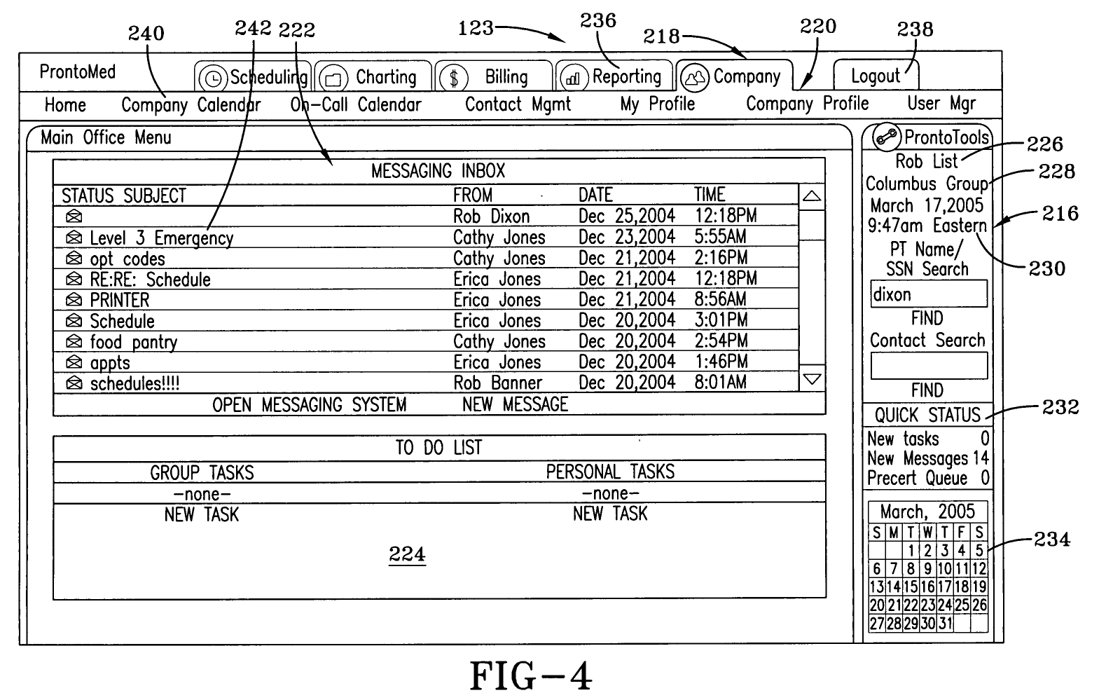

FIG. 4 shows an exemplary first screen shot 123 of a “company”or “office manager”GUI. In this embodiment, a logged-in user has a customizable environment presented. Certain elements that would be expected in the environment include a tool bar 216, a first navigation bar 218 for navigating between software applications, a second navigation bar 220 for navigating within the present software application, a messaging in-box 222 and a “to do”list box 224. Within these, the tool bar 216 displays the name 226 of the user, the name 228 of the practice, the current date and time 230, a status box 232, and a one-month calendar 234. The first navigation bar 218 provides buttons 236 that allow the user to move to the other software applications, such as the scheduling manager, the charting manager, the billing manager and the reporting manager. The first navigation bar 218 also has a logout button 238. The second navigation bar 220 allows the user to move to additional GUIs within the present software application. In this case, the present application is the “company”software application, so the buttons 240 on the second navigation bar provide a route to the home page, the company calendar, the on-call calendar, the contact manager, the personal profile, the company profile and the user manager. The messaging in-box provides brief listings 242 of the messages, so that clicking on any of them will cause display of the full message. The to-do list box 224 would display brief listings of “to-do”items in a similar manner.

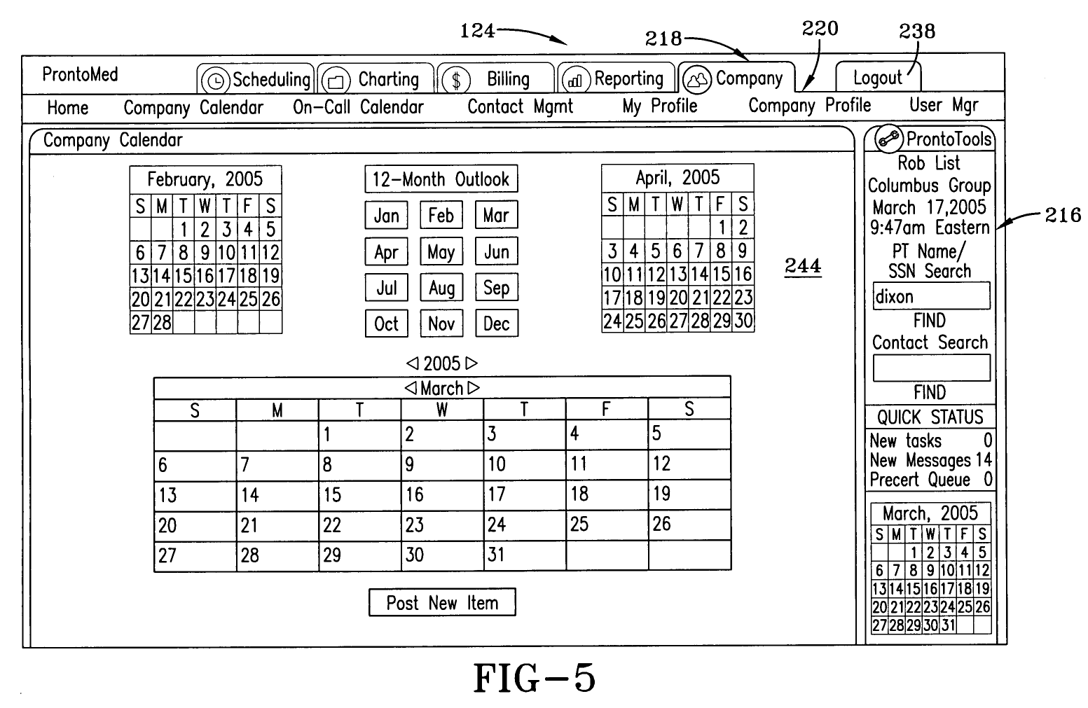

FIG. 5 shows an exemplary second screen shot 124 of a “company”or “office manager”GUI. In this embodiment, a logged-in user has a similar customizable environment to that of FIG. 4. The same tool bar 216, first navigation bar 218, second navigation bar 220, and logout button 238 are displayed. However, this screen shot 124 is arrived at by clicking on the “company calendar”button on the second navigation bar in FIG. 4, so a more detailed calendar display 244 is provided. A number of available navigation buttons within the calendar display 244 allow entry and/or display of calendar data.

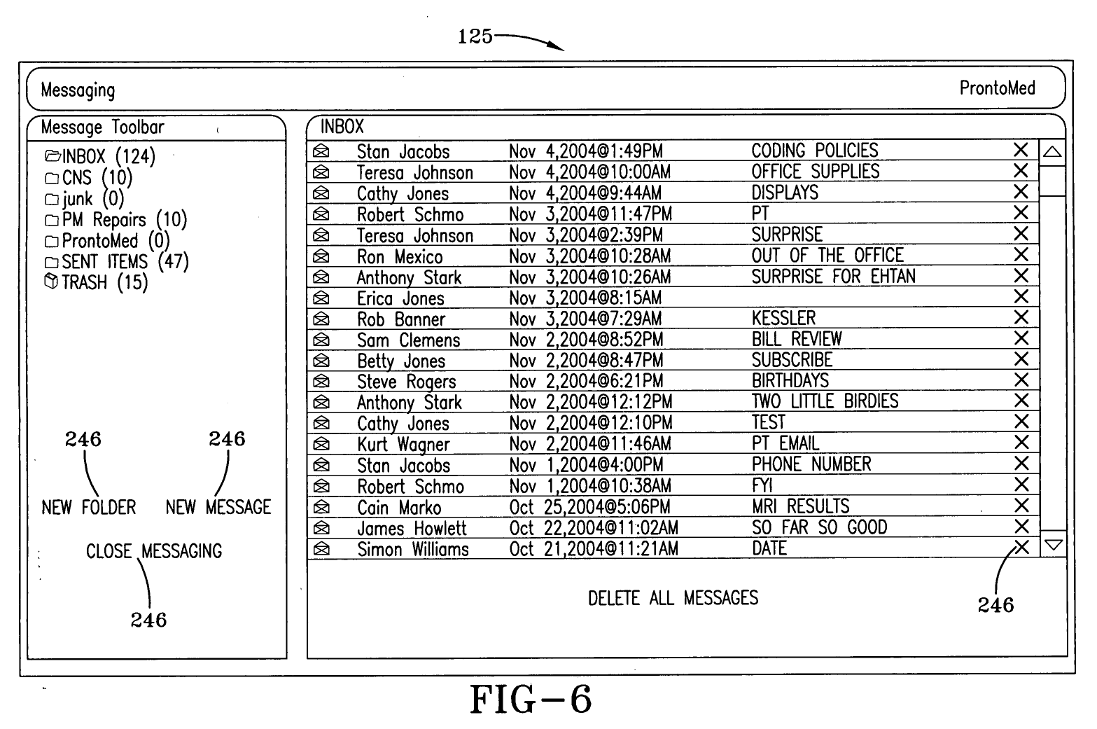

FIG. 6 shows further navigational capabilities of the present invention by means of an exemplary third screen shot 125 of a “company”or “office manager”GUI. In this embodiment, the logged-in user has a slightly different customizable environment to that of either FIG. 4 or 5. The tool bar, first and second navigation bars, and logout buttons are not displayed. This screen shot 125 is arrived at by clicking on the “open messaging system”button in the messaging inbox 222 of FIG. 4. Buttons 246 in the screen shot allow the user to perform such acts as to create a new folder, add a new message, delete all messages, delete a single message, or to close the messaging screen shot.

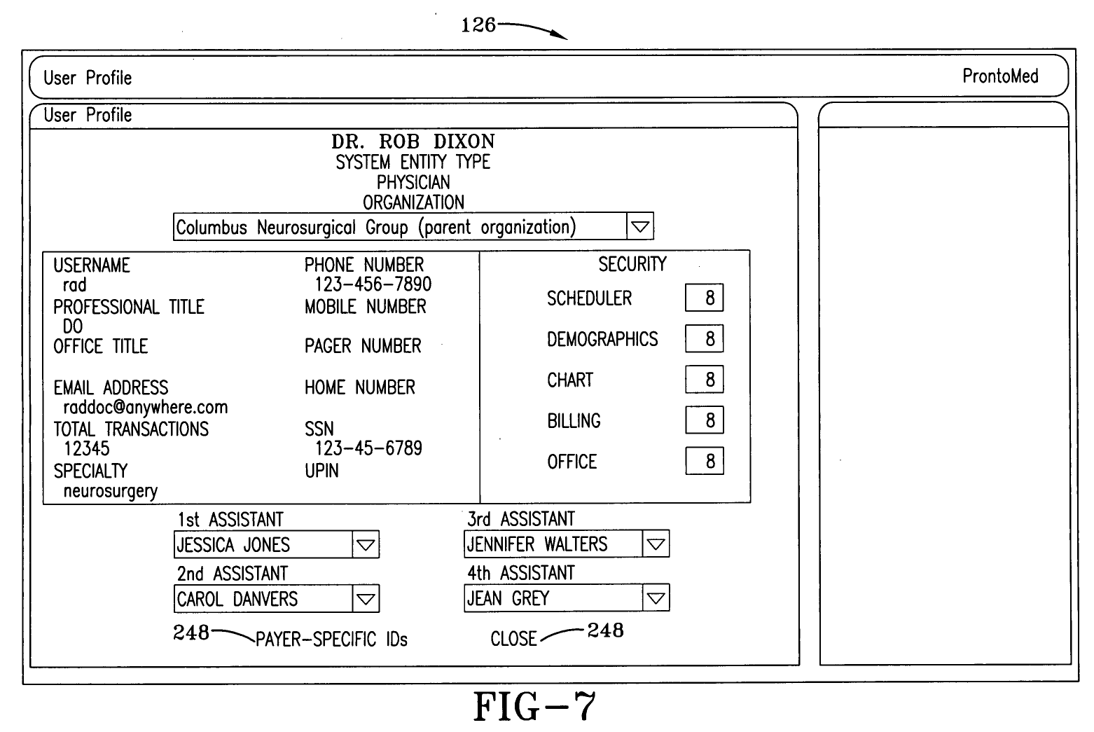

FIG. 7 shows an exemplary fourth screen shot 126 of a “company”or “office manager”GUI. As in FIG. 6, the logged-in user here has a slightly different customizable environment to that of either FIG. 4 or 5. The tool bar, first and second navigation bars, and logout buttons are not displayed. This screen shot 126 is arrived at by clicking on the “my profile”button 240 in second navigation bar 220 of FIG. 4. Buttons 248 in the screen shot allow the user to obtain “payer-specific IDs”and to “close”the screen shot 126. For security reasons, some displayed data are redacted out, although they would be visible to an authorized user.Several data entry boxes allow entry of information.

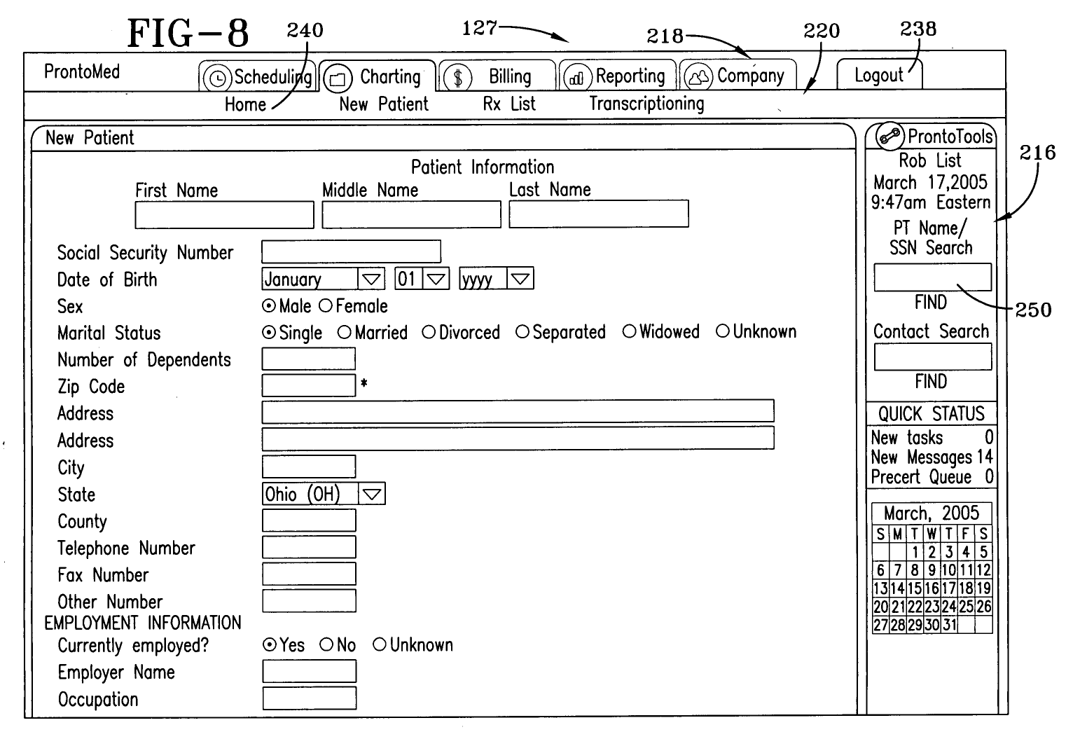

FIG. 8 shows an exemplary first screen shot 127 of a “charting manager”GUI that is a part of the charting manager software application. In this embodiment, a logged-in user has a customizable environment presented. As in the analogous FIG. 4, this view includes tool bar 216, first navigation bar 218, second navigation bar 220 and logout button 238. In this case, the second navigation bar 220 allows the user to move to additional GUIs within the charting manager software application, so the buttons 240 on the second navigation bar provide a route to the charting home page, the new patient screen, the prescription list and the transcriptioning function. The particular screen shot 127 depicted allows for direct entry and display of patient information and a search box 250 in the tool bar 216 provides the ability to search for patients by name or Social Security Number.

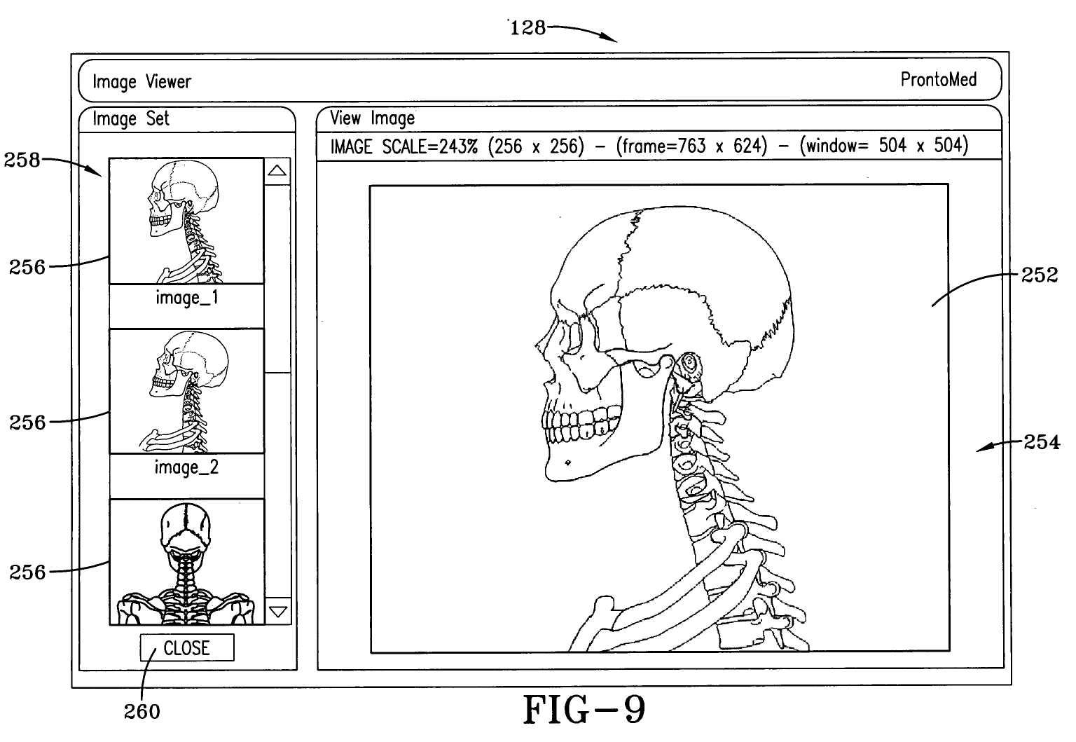

FIG. 9 is an exemplary second screen shot 128 from the charting manager software application. If a patient's associated data includes images, such as x-ray images, these images may be presented either in full view 252 in a main portion 254 of the screen or thumbnail views 256 in an “image set”box 258, which also includes a “close”button 260. Images such as those disclosed here may be deposited into the patient record through use of the “dropbox”portal of FIG. 3.

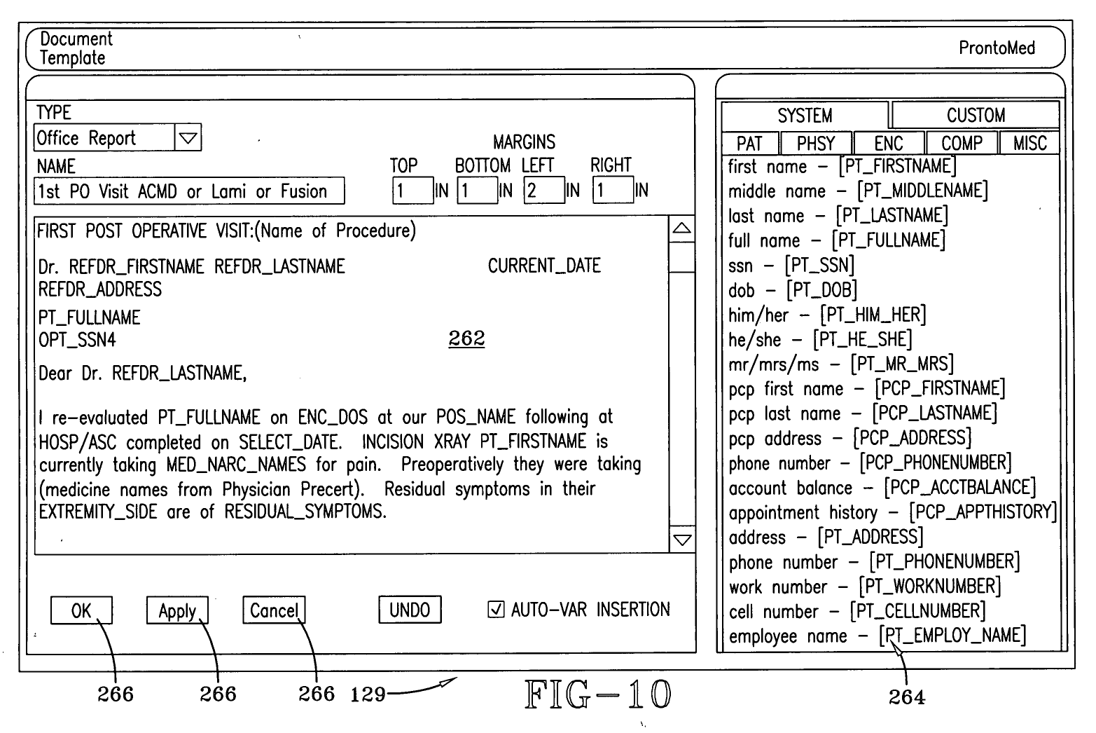

FIG. 10 depicts a portion of the transcriptioning feature of the charting manager software application as a document template GUI 129. Here, the screen is divided into a display portion 262 and a tool bar 264. A template of a report to a referring physician is shown. Buttons 266 at the bottom of the display portion 262 permit the user to “OK, “apply”or “cancel”the proposed reporting letter. Much of the variable data for the letter is provided by the transaction record being reported.

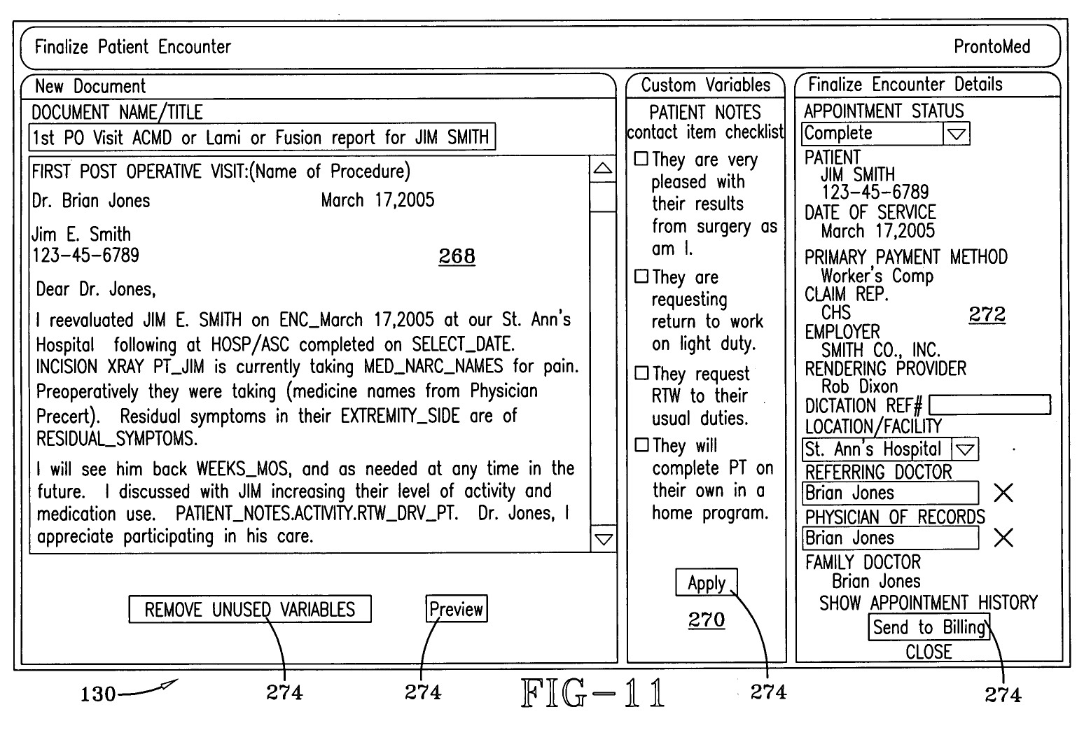

FIG. 11 shows a proposed report GUI 130, prepared using the document template GUI of FIG. 10. To protect confidential patient information, much of the patient data is redacted. The screen is divided into a display portion 268 and two tool bars 270, 272. This GUI 130 is utilized by a physician user to finalize a patient encounter and to send information to the billing manager software application, when that application is a part of the installed system. Buttons 274 in the various areas of the screen allow user action.

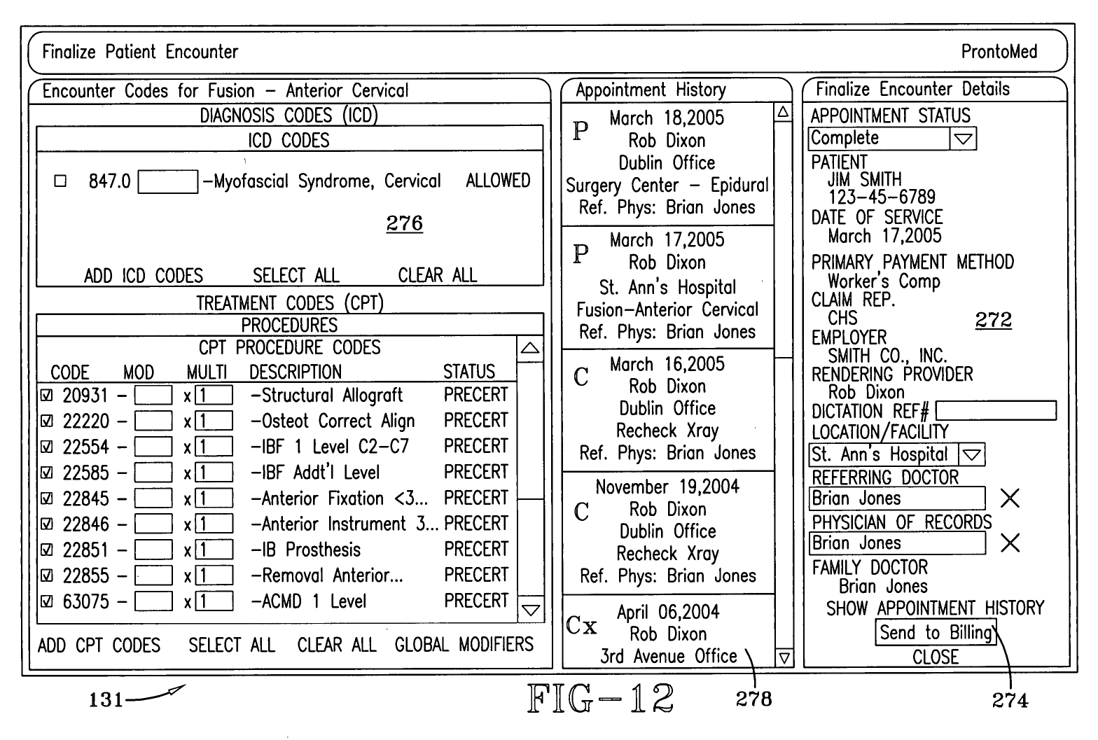

FIG. 12 shows another GUI 131, this one intended for logging patient data as a part of the transcriptioning process, which is still a part of the patient manager software application. In GUI 131, which may be used in addition to or instead of GUI 130, coding information is provided for the procedures used. Over the past 30 years, the American Medical Association (AMA) has developed a codification of medical procedures known as the “Current Procedural Terminology”or “CPT”(a federally registered trademark of AMA). CPT is a copyrighted publication of AMA that is readily available under license from AMA. CPT codes are required in many instances for the billing of medical procedures to a health care coverage provider. Similarly, the “International Classification of Diseases”or “ICD”is a standardized set of codes, developed and maintained by the National Center for Health Statistics, Hyattsville, Md. While primarily directed at standardizing designations for diseases and particularly for mortality data, the ICD also includes a classification system for surgical, diagnostic and therapeutic procedures. These codes are also required to accompany billing to some health care coverage providers. The PPMS provides lists of CPT and ICD codes for easy look up and reference by the users.

GUI 131 is divided into three sections, consisting of a diagnosis and treatment codes section 276, an appointment history section 278 and a patient details section 272, identical to the tool bar 272 in FIG. 11. As with FIG. 10, this GUI 131 may be used to finalize a patient encounter and to send information to the billing manager software application, when that application is a part of the installed system. Button 274 allows user action. The CPT codes permit reliable billing for the patient encounter.

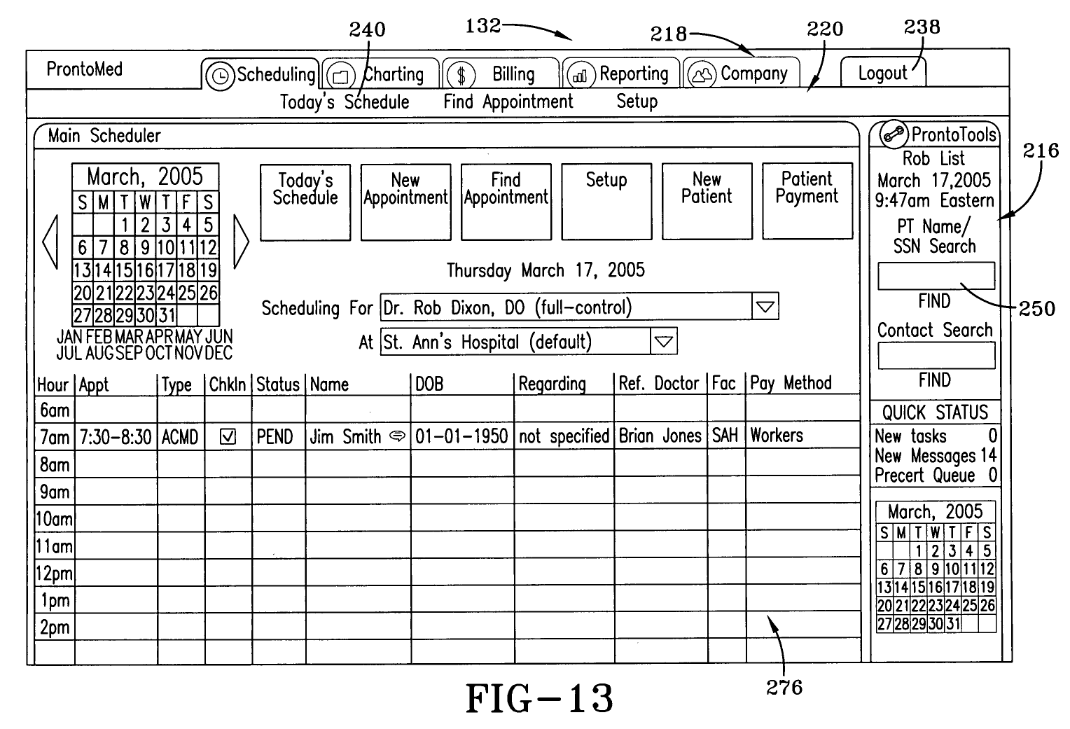

FIG. 13 shows an exemplary first screen shot 132 of a “scheduling manager”GUI that is a part of the scheduling manager software application. In this embodiment, a logged-in user has a customizable environment presented. As in the analogous FIGS. 4 and 8, this view includes tool bar 216, first navigation bar 218, second navigation bar 220 and logout button 238. In this case, the second navigation bar 220 allows the user to move to additional GUIs within the scheduling manager software application, so the buttons 240 on the second navigation bar provide a route to “today's schedule”, to search for a particular appointment and to setup an appointment. The particular screen shot 132 depicted allows for direct entry and display of patient information and a search box 250 in the tool bar 216 provides the ability to search for patients by name or Social Security Number. Some patient data has been redacted from the main display portion 276 of this image, for patient confidentiality reasons, but would be visible to an authorized user.

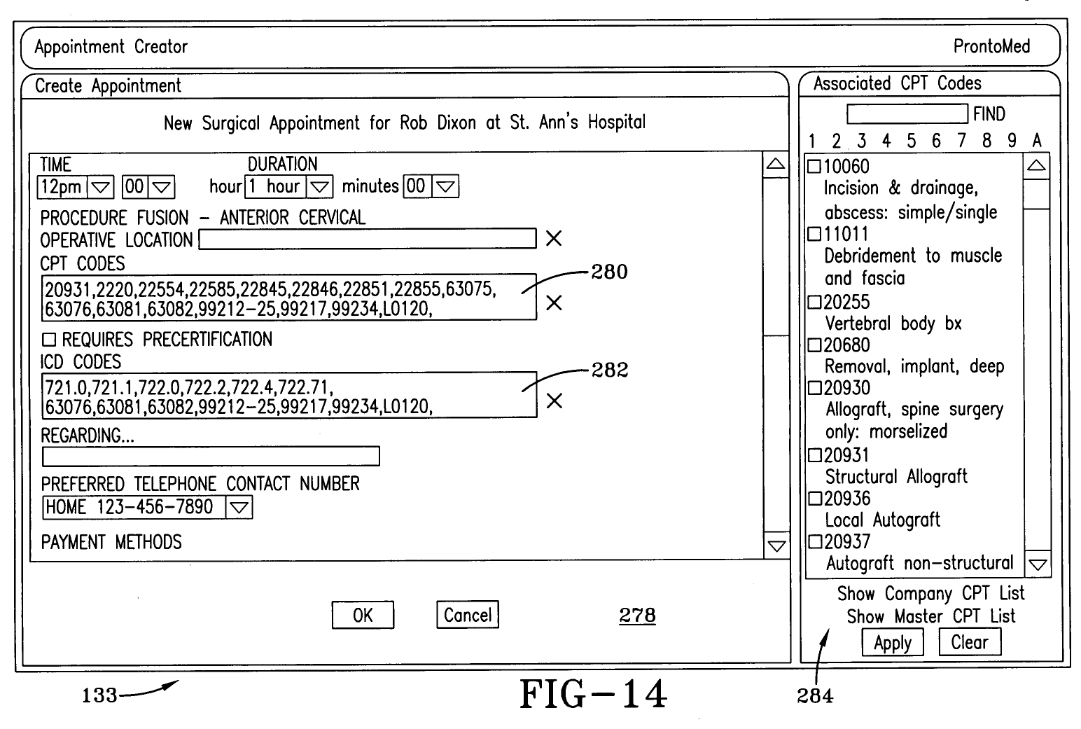

Another part of the scheduling manager software application is set up of a patient encounter or appointment. FIG. 14 shows an exemplary second screen shot 133 of a “scheduling manager”GUI that is a part of the scheduling manager software application. In this embodiment, a logged-in user has a customizable environment presented, and tool bar 216, first navigation bar 218, second navigation bar 220 and logout button 238 are not shown so that emphasis and available space may be dedicated to the particular environment. This GUI 133 may be reached, for example, from the “setup”button 240 of FIG. 13. In the major portion 278 of the screen 133, details of an appointment are itemized, including a listing 280 of CPT codes and a listing 282 of ICD codes, as described above. A second portion 284 of the screen 133 shows associated CPT codes and their meanings.

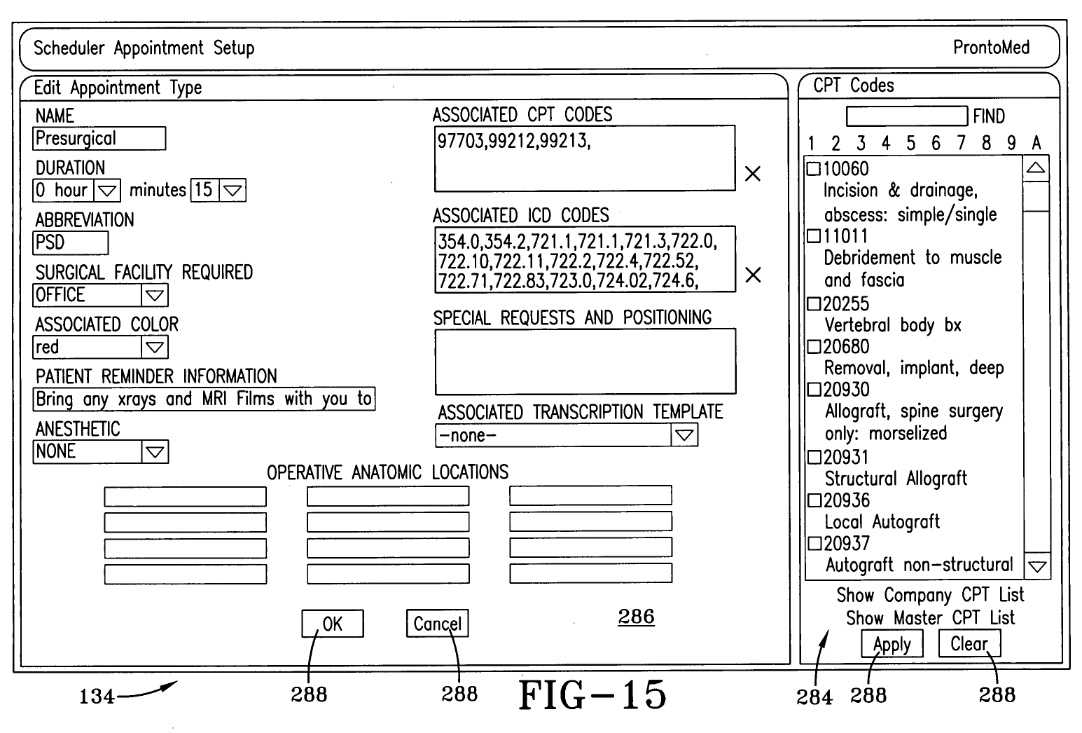

Once the procedural aspects of an appointment are established, as shown in FIG. 14, it is necessary to set up further details in a scheduler appointment setup GUI, such as that shown as 134 in FIG. 15. This screen allows an appointment to be edited, and has a major portion 286 for displaying details and a second portion 284. Buttons 288 allow the user to approve or cancel the information entered.

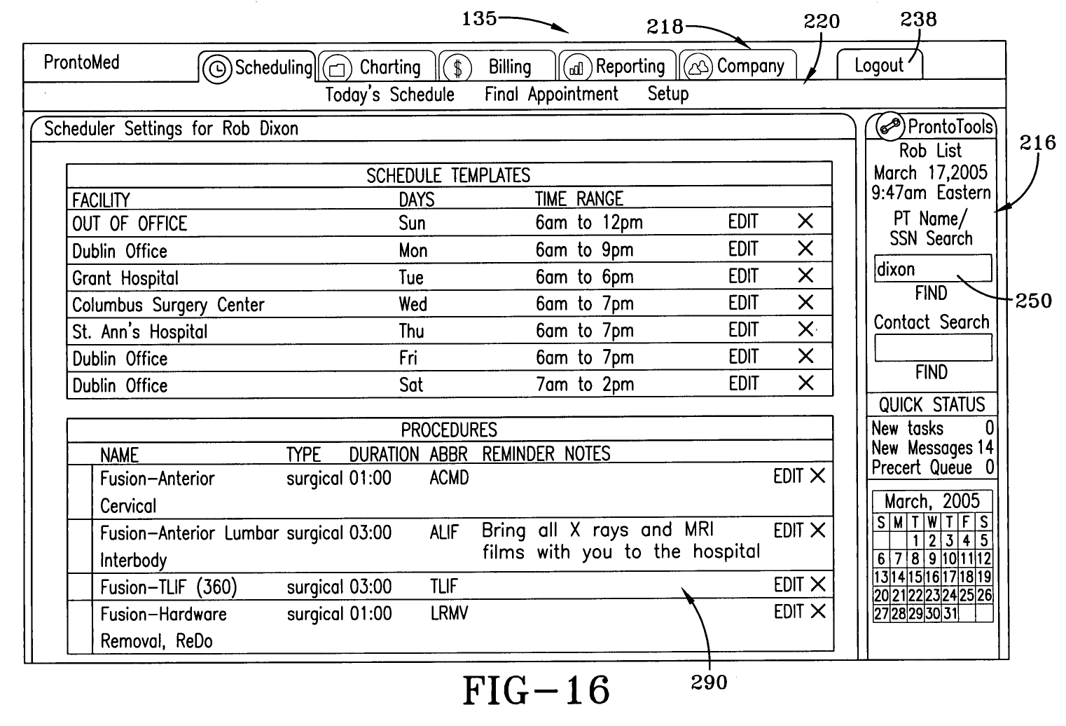

FIG. 16 is a further scheduling GUI 135 of the schedule manager software application. The tool bar 216, first navigation bar 218, second navigation bar 220 and logout button 238 are again shown and search tool 250 is again present in tool bar 216. Main portion 290 of the GUI 135 is used to show scheduling data.

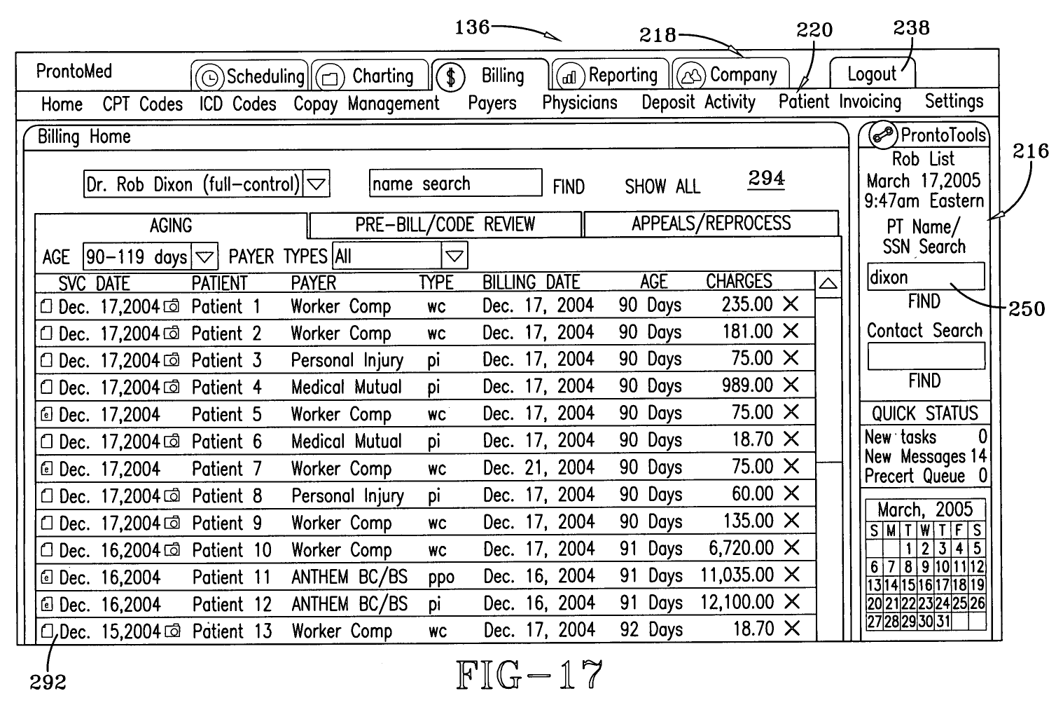

Although a primary part of the medical professional's time is dedicated to rendering the medical services to patients that he or she is licensed to render, the simple fact is that attention to payment issues, especially concerning payments from health care insurers, is an increasing part of the physician's time demand. For that reason, a billing manager software application, while not a mandatory part of the PPMS, is a highly desirable part of the package. FIGS. 17 through 23, as they will now be described, constitute an exemplary implementation of a billing manager software application of the present invention.

FIG. 17 shows an exemplary first screen shot 136 of the “billing manager home”GUI that is a part of the billing manager software application. In this embodiment, a logged-in user has a customizable environment presented. As in the analogous FIGS. 4, 8 and 13, this view includes tool bar 216, first navigation bar 218, second navigation bar 220 and logout button 238. In this case, the second navigation bar 220 allows the user to move to additional GUIs within the billing manager software application, so the buttons 240 on the second navigation bar provide a route to GUIs dedicated to CPT codes, ICD codes, Co-pay management, Payers, Physicians, Deposit activity, Patient invoicing and Settings. The particular screen shot 136 depicted displays an aging report for bills on this home screen, so a considerable amount of redaction has occurred to maintain client privacy. As in other screens, a search box 250 in the tool bar 216 provides the ability to search for patients by name or Social Security Number. Details on individual invoices may be obtained by clicking on the line items 292 on the main portion 294 of screen 136.

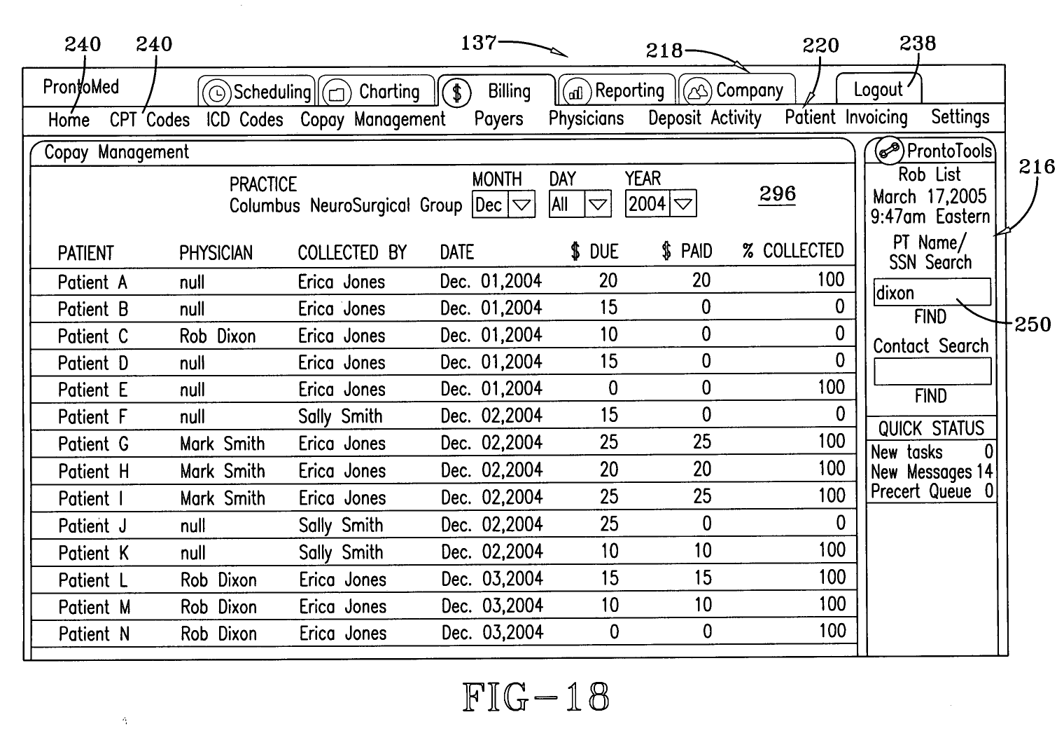

FIG. 18 shows an exemplary second screen shot 137 of the co-pay management GUI that is a part of the billing manager software application. In this embodiment, a logged-in user has the customizable environment presented, including the tool bar 216, first navigation bar 218, second navigation bar 220 and logout button 238. As with GUI 136, the second navigation bar 220 in GUI 137 allows the user to move to additional GUIs within the billing manager software application, so the buttons 240 on the second navigation bar provide a route to GUIs dedicated to the billing home, CPT codes, ICD codes, Payers, Physicians, Deposit activity, Patient invoicing and Settings. The particular screen shot 137 depicted displays, in the main portion 296, a report for an entire practice to show whether a co-pay amount has been collected from a patient. Since most patients wil have applicable insurance coverage, but will be responsible for a co-pay amount with any office visit, it is important that these co-pays are made at the time of rendering services. This screen has had patient names redacted to protect privacy, but the screen shows the patient name, the physician, the person who collected the co-pay, the amount due (since this will vary by the insurance coverage) and the amount paid. From these latter two data items, the “% collected”is calculated and displayed.

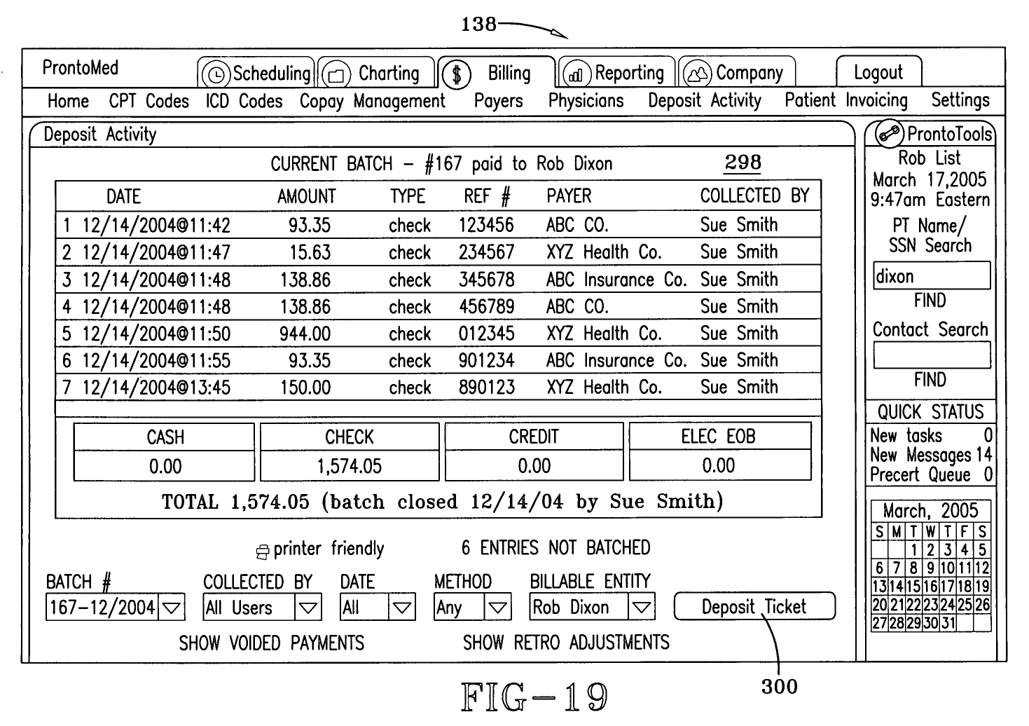

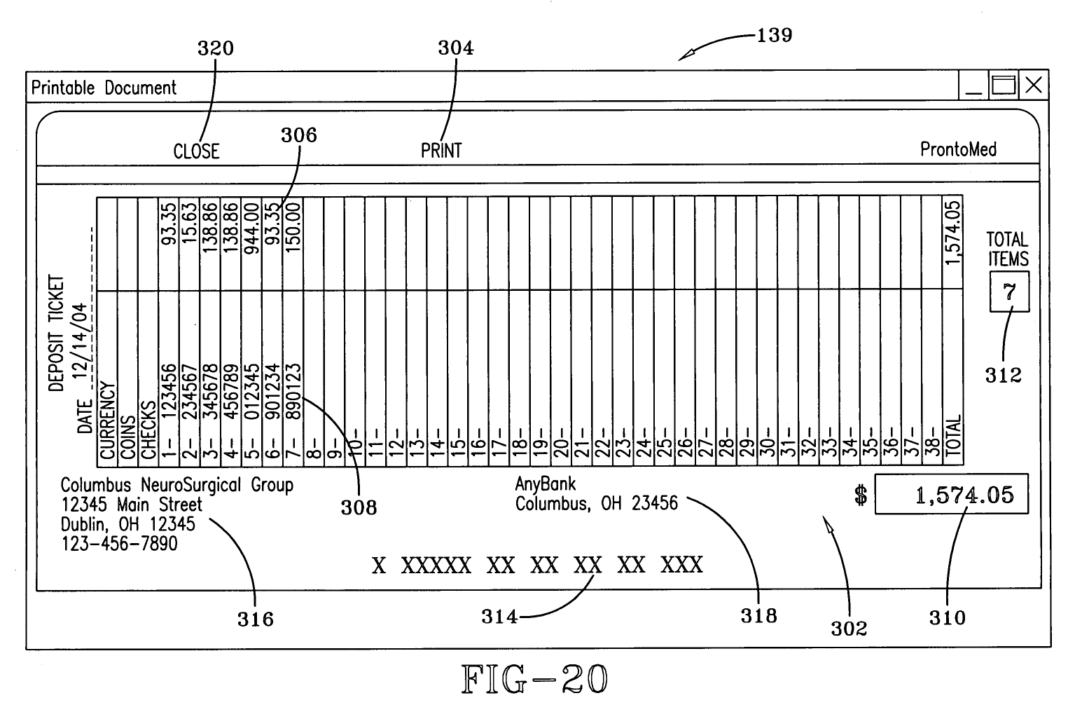

FIGS. 19 and 20 are closely related to each other and will be described together. FIG. 19 shows a screen shot 138 of a first deposit activity GUI that is a part of the billing manager software application. If the information reviewed by a user in a main portion 298 of that screen shot is acceptable, the user moves to screen shot 139 of FIG. 20 by clicking on the “deposit ticket”button 300. The information in the main portion 298 of screen shot 138 is typically generated by a staff employee who reviews and logs in payments from a number of payers. These are collected into “batches”and the batches are posted to the physician for approval. The batch report shows the date, type of payment, reference number (if applicable), payer and the collecting party, that is, the staff member. Of these, payer names and reference numbers have been redacted in this view. The report also shows a total amount collected in the batch, including any credits given.

By clicking on the “deposit ticket”button 300, a deposit ticket 302 is generated for display on the screen, as shown in FIG. 20. This deposit ticket may be printed by clicking on the “print”button 304 for use in making a bank deposit. To comply with the bank's requirements, the deposit ticket that is generated has listings by amount 306 and reference number 308 of the individual checks, as well as a total 310 and the number of total items 312 on the deposit ticket. While redacted at the intermediate portion to protect confidentiality, the account number 314 of the practice is printed out in the proper format to be read by the automated devices at the bank, but the beginning and end of the account number are shown to display the format. The deposit ticket 302 also shows the name and address 316 of the account owner and the name and address 318 of the bank where the account is located. By clicking on the “close”button 320, a user moves back to the previous billing manager screen. It is noted that the data illustrated in FIGS. 19 and 20 are not from the same transaction batch, so the number of checks in the batch and the amount do not correspond, but the appropriate relationship will be understood by one of skill without the exact correspondence being illustrated.

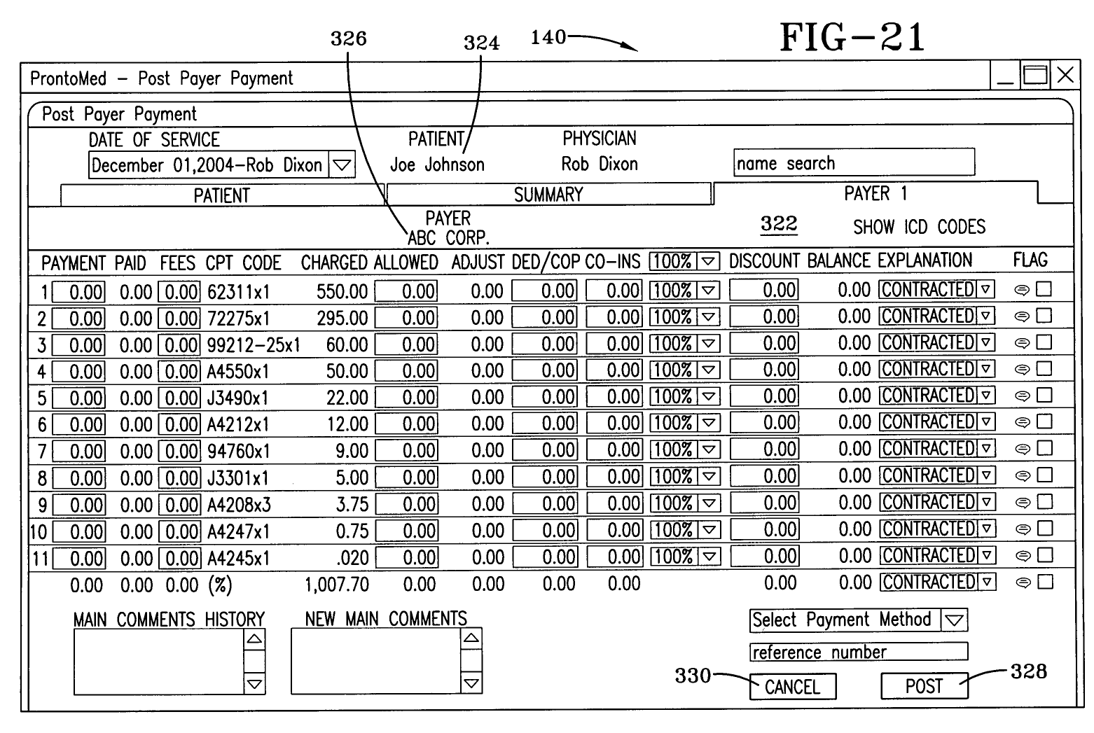

FIG. 21 shows a screen shot 140 used for monitoring and posting payments from payers, particularly from health insurance providers. This screen shot has a main portion 322 which is a summary of the billable procedures for a patient 324, to be billed to a payer 326, both of whose names are redacted to protect confidentiality. The various fields will be readily understood to anyone familiar with medical billing practice, as they show the standard fees, the amount of that fee allowed, any adjustments, deductibles, co-pay amounts and discounts, as well as an explanation field. Buttons 328, 330 are used to either “post”or to “cancel”the billing.

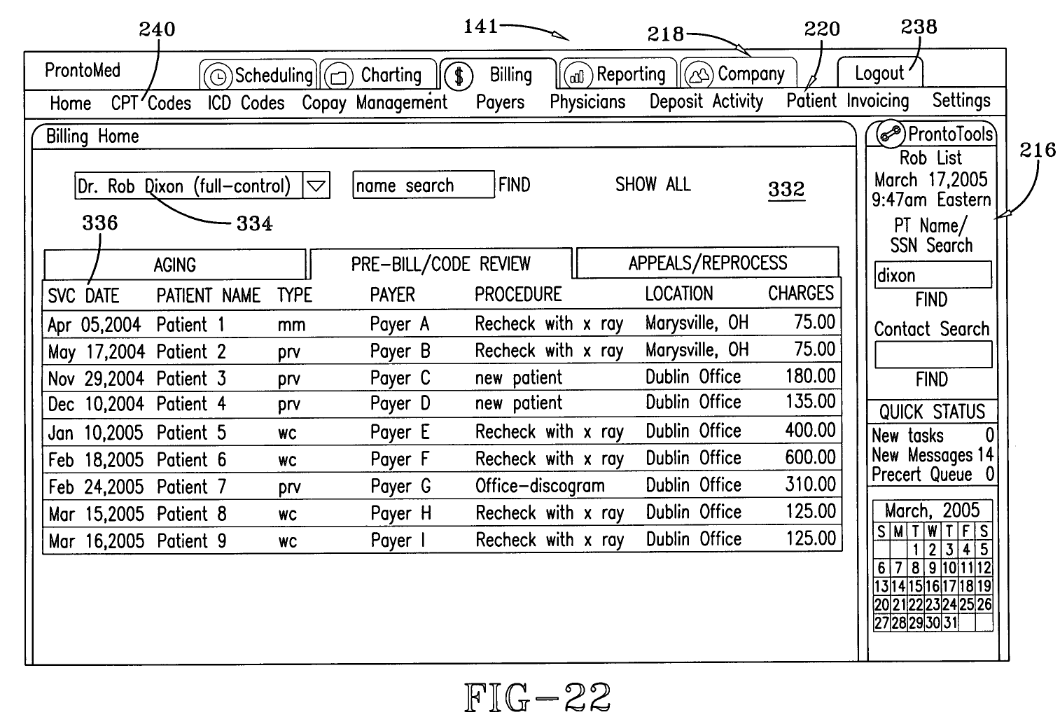

FIG. 22 is a screen shot 141 of a GUI of the billing manager software application used to provide a physician with a listing of pre-bills and code reviews for procedures he has performed, that is, patient invoicing. In this embodiment, a logged-in user has the customizable environment presented, including the tool bar 216, first navigation bar 218, second navigation bar 220 and logout button 238. The second navigation bar 220 in GUI 141 allows the user to move to additional GUIs within the billing manager software application, so the buttons 240 on the second navigation bar provide a route to GUIs dedicated to the CPT codes, ICD codes, Co-pay management, Payers, Physicians, Deposit activity, patient invoicing and Settings. A main portion 332 of the screen shot 141 represents a version of the billing home page that lists, selected for a particular physician name 334, the various records 336 available for further review or action. Each record 336 lists the service date (“SVC DATE”), patient name, patient type, payer, procedure, location, and total charges. Of these, patient names and payers have been redacted for display here.

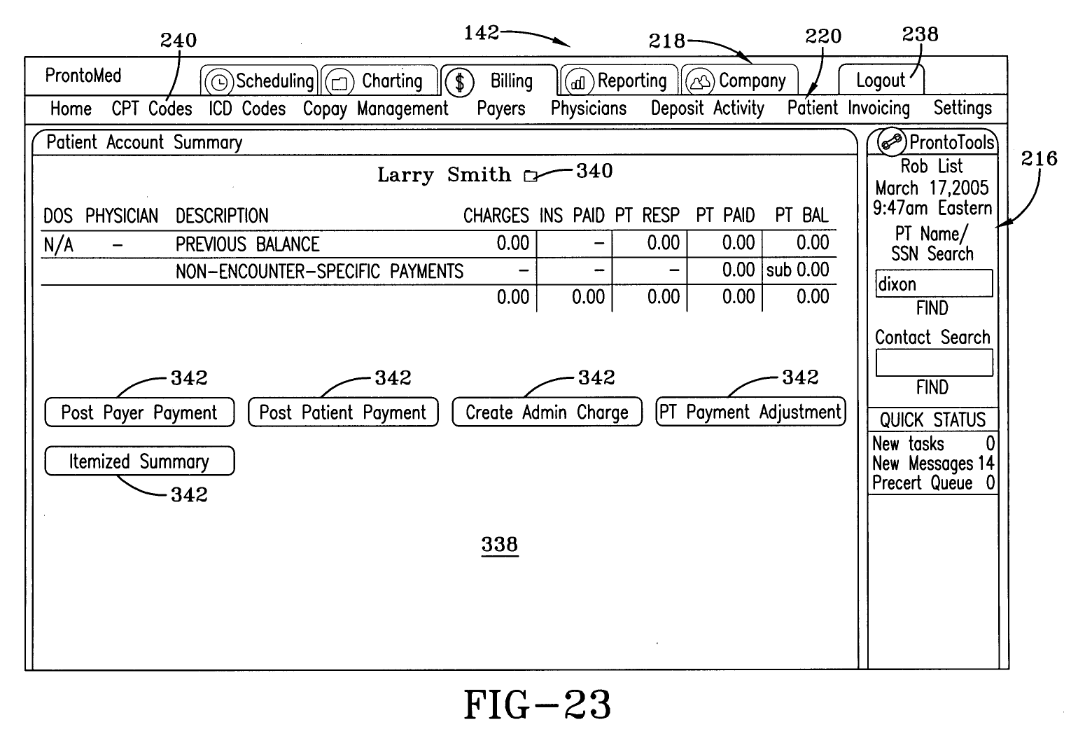

FIG. 23 is a screen shot 142 of a GUI of the billing manager software application used to provide a physician with an individual patient account record. In this embodiment, as in many others, a logged-in user has the customizable environment presented, including the tool bar 216, first navigation bar 218, second navigation bar 220 and logout button 238. The second navigation bar 220 in GUI 141 allows the user to move to additional GUIs within the billing manager software application, so the buttons 240 on the second navigation bar provide a route to GUIs dedicated to the Home, CPT codes, ICD codes, Co-pay management, Payers, Physicians, Deposit activity, patient invoicing and Settings. A main portion 338 of the screen shot 142 represents a summary of the charges and payments from both the insurance carrier and the patient, whose name is redacted, and a “folder”symbol 340 allows the user, if authorized, the mine down into the patient's chart, although this detail can be restricted, based upon the user's access level. A number of buttons 342 allow the user to mine down into biling detail, such as the “post payer payment”button, which would link the user to screen shot 140 as illustrated in FIG. 21. Also included in the buttons 342 are links to screen shots to post patient payments, create administrative charges, adjust patient payments or to provide an itemized summary.

In summary, a system and method provide secure, HIPM compliant web-based office management capability such that office management information is easily accessed, used and edited using a simple hardware device connected with a web browser to an integrated website resident on a remote server computer.

While the invention has been described with reference to certain embodiments, it will be understood by those skilled in the art that various changes may be made and equivalents may be substituted without departing from the scope o f the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for managing a professional practice office, comprising:
at least one server computer;
an integrated website, hosted on the at least one server computer, the integrated website providing a plurality of integrated office management software applications and associated graphical user interface views; and
at least one hardware device, adapted for secure electronic connection to the integrated website.

2. The system of claim 1, wherein:
the secure electronic connection is provided by the internet, and
at least one of the at least one hardware devices is provided with a network browser software package to access the integrated website.

3. The system of claim 1, wherein:
the at least one hardware device is selected from the group consisting of: desktop personal computers, personal data assistants, laptop personal computers, notebook personal computers and tablet personal computers.

4. The system of claim 2, wherein:
the at least one hardware device is selected from the group consisting of: desktop personal computers, personal data assistants, laptop personal computers, notebook personal computers and tablet personal computers.

5. The system of claim 1, wherein:
the integrated website is adapted to provide software applications and associated graphical user interface views for use in managing a medical practice, a surgical practice or a combined medical/surgical practice.

6. The system of claim 4, wherein:
the integrated website is adapted to provide software applications and associated graphical user interface views for use in managing a medical practice, a surgical practice or a combined medical/surgical practice.

7. The system of claim 1, further comprising:
means for storing and accessing data for the integrated website, connected to or integral with the at least one server computer.

8. The system of claim 6, further comprising:
means for storing and accessing data for the integrated website, connected to or integral with the at least one server computer.

9. The system of claim 6, wherein:
the plurality of integrated office management software applications comprises at least two of the following: a secured log-in portal software application, an office manager software application; a patient information software application, a schedule manager software application, and a reporting software application.

10. The system of claim 9, wherein:
the plurality of integrated office management software applications further comprises a billing manager software application.

11. The system of claim 9, wherein:
the secured log-in portal software provides a drop box for remote electronic entry of pre-authorized information.

12. The system of claim 10, wherein:
the billing manager software application provides the filing of claims with health insurance providers, tracking of billing and collections and patient invoicing.

13. The system of claim 5, wherein:
the secure electronic connection is adapted to fully comply with medical data privacy rules and regulations.

14. A method for managing a professional medical practice office, comprising the steps of:
providing an integrated website on a server computer, the integrated website having at least two integrated office management software applications, each of the integrated office management software applications having at least one graphical user interface view associated therewith
allowing secure access to the integrated website by a plurality of users using network browser software installed on a hardware device remote from the server computer;
allowing the plurality of users to individually perform office management functions using the graphical user interface views associated with any one of the office management software applications; and
allowing the plurality of users to move seamlessly from the one office management software application to another of the offcie management software applications.

15. The method of claim 14 wherein:
the secure access is accomplished through an encrypted internet connection.

16. The method of claim 14, wherein:
the at least two integrated office management software applications are selected from a group consisting of:
an office manager software application;
a chart manager software application; and
a schedule manager software application.

17. The method of claim 16, wherein:
the at least two integrated office management software applications further comprises a billing manager software application.

18. The method of claim 14, further comprising the step of:
accessing and storing data for the integrated website on a database connected to or integral with the server computer.

19. The method of claim 14, wherein:
the step of allowing secure access is adapted to fully comply with medical data privacy rules and regulations.
